(19) United States
(12) Patent Application Publication
(10) Pub. No.: US 2007/0147511 A1
(43) Pub. Date: Jun. 28, 2007

(54) IMAGE PROCESSING APPARATUS AND IMAGE PROCESSING METHOD

(75) Inventors: Takaya Ogawa, Chiba (JP); Kiwamu Watanabe, Kanagawa (JP); Tatsuhiro Suzumura, Kanagawa (JP); Satoshi Takekawa, Kanagawa (JP); Hiromitsu Nakayama, Kanagawa (JP); Yoshinori Shigeta, Kanagawa (JP); Akihiro Oue, Kanagawa (JP); Shuji Michinaka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/611,962

(22) Filed: Dec. 18, 2006

(30) Foreign Application Priority Data
Dec. 27, 2005 (JP) 2005-374707

(51) Int. Cl. H04N 11/04; H04B 1/66

(52) U.S. Cl. 375/240.24; 375/240.29

(57) ABSTRACT

An image processing apparatus includes: a frame memory; a buffer memory that stores pixel values of macroblocks of a first region including a first macroblock; a deblocking filter unit that is operable to: (1) read out the pixel values of the first region from the buffer memory; (2) apply the deblocking filter to the first macroblock; and (3) store the pixel values back into the buffer memory; and a pixel transfer unit that is operable to: (4) transfer pixel values of a macroblock not included in a second region that includes a second macroblock to be processed next to the first macroblock, from the buffer memory to the frame memory; and (5) transfer pixel values of a macroblock included in the second region but not included in the first region, from the frame memory to the buffer memory.

### RELATED APPLICATION(S)

The present disclosure relates to the subject matter contained in Japanese Patent Application No. 2005-374707 filed on Dec. 27, 2005, which is incorporated herein by reference in its entirety.

### FIELD

The present invention relates to an image processing apparatus and a method for processing image that applies a deblocking filter to images.

### BACKGROUND

As methods for encoding video image, there are MPEG-2 (Moving Picture Experts Group phase 2) currently employed in a DVD and MPEG-4 (Motion Picture Experts Group phase 4) enabling the distribution of images with a relatively low image quality and with a high compression ratio.

Examples are described in JP-A-2005-094212 and in U.S. Pat. No. 6,671,418 B1.

In addition to these video encoding methods, the standard called VC-1 is proposed to SMPTE (Society of Motion Picture and Television Engineers).

Details of the VC-1 standard are described in US 2005/0084012 A1 and in the following document.

SMPTE Draft Standard for Television, SMPTE 421M, 2005-08-23

VC-1 is same as MPEG-2 in a point that VC-1 is based on the moving compensation and DCT (Discrete Cosine Transform) but differs in a point that VC-1 can select four kinds of block sizes in total, that is, “4×8”, “8×4” and “8×8” as well as “4×4” in the block sizes of DCT. Thus, images decoded by VC-1 remain a periodically-changing granular feeling and so can advantageously represent texture of a film.

The image processing apparatus of the VC-1 standard includes a deblocking filter for reducing the blocking noise of decoded images. In VC-1, the deblocking filter is used at a stage of generating prediction images which is the final stage of a decoding procedure in the image processing apparatus. Thus, the deblocking filter is required to accurately process in accordance with a prescribed procedure.

In order to meet this requirement, in the image processing apparatus of the related art, the following procedures are defined to be performed for each image:

(1) obtaining a single sheet of image that is decoded at a timing immediately before the deblocking filter; and

(2) applying the deblocking filter to the boundaries among the blocks of the single sheet of image obtained in the procedure (1).

In this manner, in the image processing apparatus of the related art, after decoding the entirety of a single sheet of image as a decoded image, the deblocking filter is applied to the entirety of the image at the last procedure.

However, in the case of applying the deblocking filter in the aforesaid procedures, there arises a problem that the reading and writing operations of the respective pixel data of an image arise frequently.

In a deblocking filter, it is required to process three kinds of pixel values of a luminance component Y, a color difference component Cb and a color difference component Cr as to each pixel. In the case of applying the deblocking filter in the aforesaid procedures, there arises a problem that the processing delays since the reading and writing operations of a frame memory arise frequently.

### SUMMARY

According to one aspect of the invention, there is provided an image processing apparatus that applies a deblocking filter to an image. The apparatus includes: a frame memory; a buffer memory that stores pixel values of macroblocks of a first region including a first macroblock; a deblocking filter unit that is operable to: (1) read out the pixel values of the first region from the buffer memory; (2) apply the deblocking filter to the first macroblock; and (3) store the pixel values being applied with the deblocking filter back into the buffer memory; and a pixel transfer unit that is operable to: (4) transfer pixel values of a macroblock not included in a second region that includes a second macroblock to be processed next to the first macroblock, from the buffer memory to the frame memory; and (5) transfer pixel values of a macroblock included in the second region but not included in the first region, from the frame memory to the buffer memory.

### BRIEF DESCRIPTION OF THE DRAWINGS

In the accompanying drawings:

FIG. 1 is a diagram showing the configuration of an image processing apparatus according to an embodiment of the invention;

FIG. 2 is a flowchart of an image processing method according to the embodiment of the invention;

FIG. 3 is a diagram fro explaining input pixels in the case of applying a deblocking filter to two pixels at a boundary in the image processing apparatus according to the embodiment of the invention;

FIG. 4 is a diagram fro explaining the region of pixel values stored in a buffer memory in a case of applying the deblocking filter to the pixel values of a luminance component in the image processing apparatus according to the embodiment of the invention;

FIG. 5 is a diagram fro explaining the region of pixel values stored in the buffer memory in a case of applying the deblocking filter to the pixel values of a color difference component in the image processing apparatus according to the embodiment of the invention;

FIG. 6 is a diagram for explaining the order of applying the deblocking filter to the pixel values of the luminance component Y of a single macroblock of a progressive picture or an interlace field picture in the image processing apparatus according to the embodiment of the invention;

FIG. 7 is a diagram for explaining the order of applying the deblocking filter to the pixel values of the color difference component Cb of a single macroblock of a progressive picture or an interlace field picture in the image processing apparatus according to the embodiment of the invention;

FIG. 8 is a diagram for explaining the order of applying the deblocking filter to the pixel values of the luminance component Y of a single macroblock of an interlace frame picture in the image processing apparatus according to the embodiment of the invention;

FIG. 9 is a diagram for explaining the order of applying the deblocking filter to the pixel values of the color difference component Cb of a single macroblock of an interlace frame picture in the image processing apparatus according to the embodiment of the invention;

FIG. 10 is a diagram for explaining the order of applying the deblocking filter to a progressive picture or an interlace field picture in the image processing apparatus of a related art;

FIG. 11 is a diagram for explaining the order of applying the deblocking filter to an interlace frame picture in the image processing apparatus of the related art;

FIG. 12 is a diagram fro explaining the region of pixel values stored in the buffer memory in a case of applying the deblocking filter to the pixel values of the luminance component in the image processing apparatus according to a modified example of the embodiment of the invention; and

FIG. 13 is a diagram fro explaining the region of pixel values stored in the buffer memory in a case of applying the deblocking filter to the pixel values of the color difference component in the image processing apparatus according to the modified example of the embodiment of the invention.

### DETAILED DESCRIPTION OF THE EMBODIMENT(S)

An embodiment of the present invention will be described below with reference to the drawings. In the following description of the drawings, same or similar portions are marked with same or similar symbols, respectively.

An embodiment of the invention will be explained as to a case where a deblocking filter is applied to a single image data on a macroblock unit basis in the order of the raster scanning from the left uppermost macroblock to the right lowest macroblock. To be concrete, the deblocking filter is applied to each of the macroblocks on the uppermost line of the image data while these macroblocks are scanned from the left to the right. Thereafter, the deblocking filter is applied to each of the macroblocks on the second line while these macroblocks are scanned from the left to the right.

An image processing apparatus 1 according to the embodiment of the invention will be explained with reference to FIG. 1. When the image processing apparatus 1 according to the embodiment of the invention receives a bitstream D01, the image processing apparatus decodes the input bitstream and outputs a decoded image D02. The decoded image D02 thus output may be a motion picture image data or a still image.

The image processing apparatus 1 includes a variable length code decoding unit 11, an inverse-quantization and inverse-orthogonal-transform unit 12, a prediction pixel transfer unit 13, an inter-frame prediction pixel interpolation unit 14, an inter-frame prediction application unit 15, a buffer memory 16, a deblocking filter unit 17, a pixel transfer unit 18 for a deblocking filter and a frame memory 19.

The variable length code decoding unit 11 decodes variable length codes of the bitstream D01 to obtain values of parameters such as quantized transform coefficients and motion vectors that are required in a succeeding stage. The quantized transform coefficient output from the variable length code decoding unit 11 is input into the inverse-quantization and inverse-orthogonal-transform unit 12. The motion vector output from the variable length code decoding unit 11 is input into the prediction pixel transfer unit 13.

The inverse-quantization and inverse-orthogonal-transform unit 12 multiplies the quantized transform coefficient input from the variable length code decoding unit 11 by a quantization parameter to acquire a transform coefficient. The inverse-quantization and inverse-orthogonal-transform unit 12 conducts the inverse-transformation of the acquired transform coefficient to obtain a pixel value or an inter-frame prediction residual error. The data output from the inverse-quantization and inverse-orthogonal-transform unit 12 is input into the inter-frame prediction application unit 15.

The prediction pixel transfer unit 13 receives the motion vector input from the variable length code decoding unit 11 and transfers a region necessary for a reference image used for the inter-frame prediction from the frame memory 19. The data acquired by the prediction pixel transfer unit 13 is input into the inter-frame prediction pixel interpolation unit 14.

The inter-frame prediction pixel interpolation unit 14, when referring to a coordinate in which a motion vector is a unit smaller than an integer number of pixel or pixels, interpolates the reference image to obtain a pixel value of a intermediate point and outputs the reference image. The data output from the inter-frame prediction pixel interpolation unit 14 is input into the inter-frame prediction application unit 15.

The inter-frame prediction application unit 15 obtains a pixel value based on the reference image obtained by the inter-frame prediction pixel interpolation unit 14 and on the inter-frame prediction residual error obtained by the inverse-quantization and inverse-orthogonal-transform unit 12. The inter-frame prediction application unit 15 calculates three kinds of pixel values of a luminance component Y, a color difference component Cb and a color difference component Cr as to each pixel and outputs these pixel values to the buffer memory 16.

The buffer memory 16 stores pixel values required for the processing in the deblocking filter unit 17. The buffer memory 16 stores the pixel values transferred from the frame memory 19 by the pixel transfer unit 18 for a deblocking filter as well as the pixel values calculated by the inter-frame prediction application unit 15. Besides, the buffer memory 16 also stores pixel images which are obtained by applying the deblocking filter in the deblocking filter unit 17. The buffer memory 16 may be a single memory or may be divided into plural memories according to the positions of the pixels to be stored.

From buffer memory 16 the deblocking filter unit 17 reads the pixel values of a region necessary for the deblocking filtering of a predetermined macroblock, applies deblocking filter for the predetermined macroblock and writes back the resultant pixel values to the same buffer memory 16. In the embodiment, the deblocking filter unit 17 applies the deblocking filter on a macroblock unit basis. The macroblock is defined as 16 pixels×16 pixels as to the luminance component Y, and 8 pixels×8 pixels as to the color difference component Cb and the color difference component Cr. After the inter-frame prediction application unit 15 calculates writes the pixel values of a macroblock to the buffer memory 16, the deblocking filter unit 17 starts reading and applying the deblocking filter to the macroblock.

The calculation of the pixel values by the inter-frame prediction application unit 15 and the application of the deblocking filter by the deblocking filter unit 17 may be processed in parallel by a pipeline system. To be concrete, when the deblocking filter unit 17 applies the deblocking filter to the predetermined macroblock, the inter-frame prediction application unit 15 may simultaneously calculates the pixel values of the next macroblock.

The pixel transfer unit 18 for a deblocking filter transfers the pixel values of a macroblock not referred to by the deblocking filter unit 17 to the frame memory 19 from the buffer memory 16. For example, the explanation will be made as to a case where the buffer memory 16 stores the pixel values of a first region which is input in order to apply the deblocking filter to a first macroblock. In the case of applying the deblocking filter to a second macroblock to be processed next to the first macroblock, the pixel transfer unit 18 for a deblocking filter transfers, from the buffer memory to the frame memory, the pixel values of a macroblock not contained in a second region which is input in order to apply the deblocking filter to the second macroblock. In this case, the pixel values transferred from the buffer memory 16 are deleted. Alternatively, the buffer memory 16 is controlled in a manner that new pixel values are stored in a region where the pixel values transferred from the buffer memory 16 are stored. Further, the pixel transfer unit 18 for a deblocking filter stores the pixel values of a macroblock which are contained in the second region but not contained in the first region, into the buffer memory 16 from the frame memory 19. In this case, the pixel values of the macroblock which are contained in the second region but not contained in the first region may be stored in the region where the pixels transferred by the pixel transfer unit 18 for a deblocking filter are stored or may be stored in another free region.

The frame memory 19 stores via the pixel transfer unit 18 for a deblocking filter the pixel values obtained by applying the deblocking filter. The values stored in the frame memory 19 are read by the prediction pixel transfer unit 13 and the pixel transfer unit 18 for a deblocking filter.

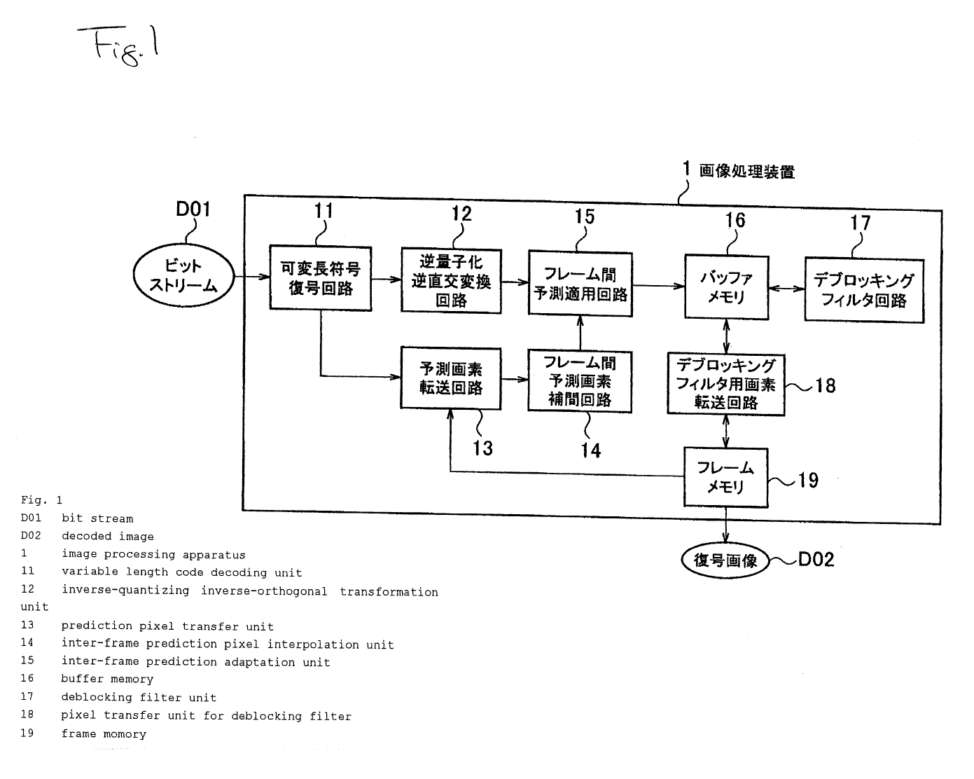

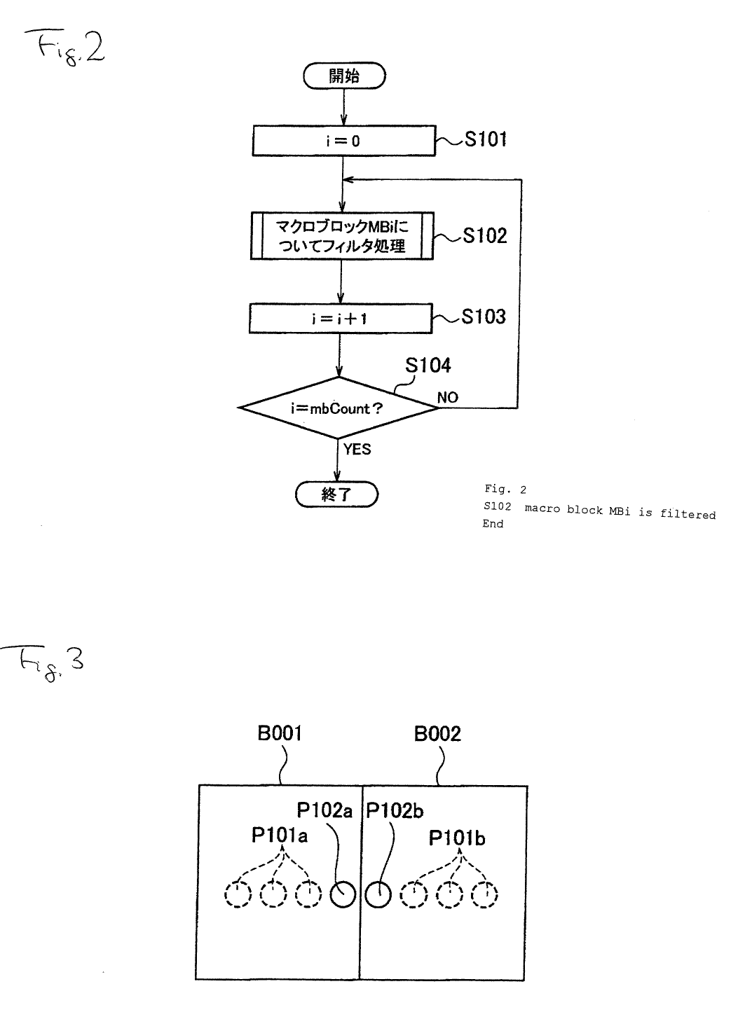

Next, a method for processing image according to the embodiment of the invention will be explained as to the processing in the case of applying the deblocking filter with reference to FIG. 2.

First, in step S101, a variable “i” is initialized. The variable “i” represents a macroblock number allocated in the raster scanning order in a manner that the uppermost left one of a decoded image is 0. Although there is no macroblock outside of the decoded image, the macroblock number is allocated as if there are macroblocks in the lower direction exceeding the vertical range of the decoded image.

Next, in step S102, the deblocking filter unit 17 applies the deblocking filter to a macroblock MBi specified by the variable “i”. Further, in step S103, the variable “i” is incremented.

In step S104, it is determined whether or not the variable “i” is a constant mbCount. The mbCount is the mumber of the macroblocks to which the deblocking filter is applied in the decoded image. To be concrete, the mbCount is represented by a number obtained by multiplying the number of the macroblocks in the horizontal direction and the sum of 1 and the number of the macroblocks in the vertical direction. The filtering processing in step S102 is repeated for the number of times equal to mbCount, that is, from “i=0” to “i=mbCount−1”.

The step S102 shown in FIG. 2 is executed for each of the luminance component, the color difference component Cb and the color difference component Cr of the decoded image.

Although the image processing method according to the embodiment is explained with reference to the flowchart shown in FIG. 2, the invention is not limited to this processing. The order of the respective steps and the termination condition of the loop etc. may be changed suitably.

An explanation will be made as to a processing for applying the deblocking filter according to the embodiment of the invention with reference to FIGS. 3-11.

As shown in FIG. 3, the deblocking filter is applied to the boundary between the blocks of a sheet of image. Two quadrangles shown in FIG. 3 represent adjacent two blocks B001 and B002. In FIG. 3, each of the circles within each of the blocks B001 and B002 represents a single pixel. Pixels P102a and P102b each shown by circles of a solid line are blocks located at the boundary. Pixels P101a and P101b each shown by circles of a dotted line are pixels used for the deblocking filter processing of the pixels P102a and P102b located at the boundary. In the case of applying the deblocking filter to the pixels P102a and P102b located at the boundary, the pixels P101a, P101b, P102a and P102b are input.

Next, explanation will be made as to a region necessary in the case of applying the deblocking filter to the predetermined macroblock.

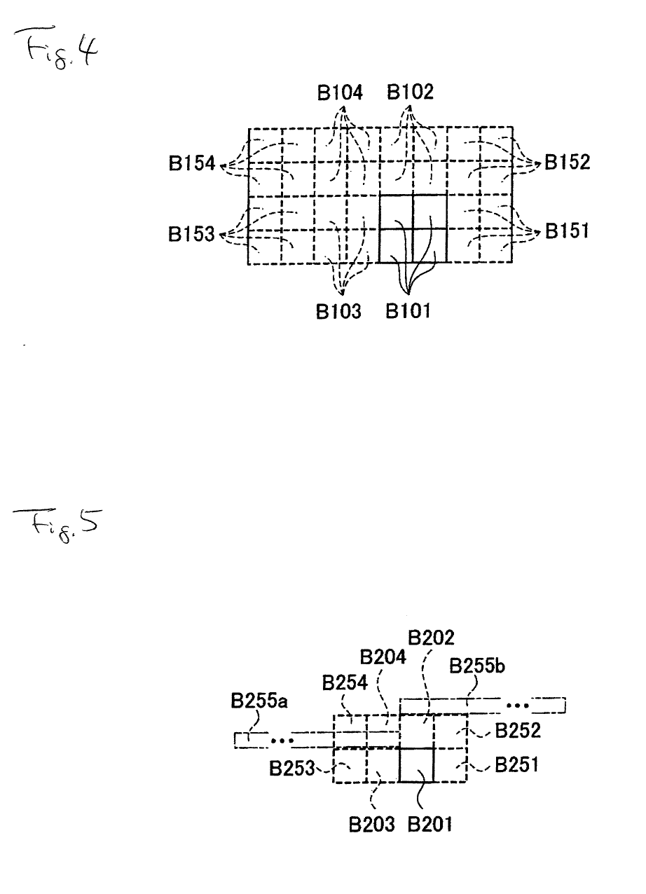

FIG. 4 is a diagram for explaining the processing of applying the deblocking filter as to the pixel values of the luminance component. In the case of applying the deblocking filter to the luminance component of a macroblock B101 shown by a solid line shown in FIG. 4, the pixel values of in a region shown in FIG. 4 are stored in the buffer memory 16. The regions shown by dotted lines represent the peripheral pixels of the macroblock to be processed.

In the region shown in FIG. 4, the macroblock B101 currently processed, a macroblock B103 having been processed just before, a macroblock B102 which display position locates above the macroblock B101 and a macroblock B104 which display position locates above the macroblock B103 are input into the deblocking filter unit 17 when the deblocking filter is applied to the macroblock B101. The macroblocks B102 and B104 are adjacent to the macroblocks B101 and B103 in the direction orthogonal to the scanning direction, respectively, and already have been subjected to the deblocking filtering processing. When one of the macroblocks B101 to B104 is located outside of the decoded image, the contents of the outside region may be arbitrary.

A macroblock B151 is a macroblock to be processed next to the macroblock currently being processed. A macroblock B153 is a macroblock having been processed before the macroblock which was processed before the macroblock currently being processed. A macroblock B152 is a macroblock which display position locates above the macroblock B151. A macroblock B154 is a macroblock which display position locates above the macroblock B153. The macroblocks B152 and B154 are adjacent to the macroblocks B151 and B153 in the direction orthogonal to the scanning direction, respectively, and already have been subjected to the deblocking filtering processing. When one or ones of the macroblocks B151 to B154 is located outside of the decoded image, the contents of the outside region may be arbitrary.

The macroblocks B101 to B104 and B151 to B154 may be stored in different buffer memories, respectively, or may be stored in a single buffer memory.

Next, the explanation will be made as to the processing for the pixel values of the region shown in FIG. 4. First, the inter-frame prediction application unit 15 writes the pixel values for the macroblock B151 in the buffer memory 16. Further, the deblocking filter unit 17 is operated succeeding to or in parallel to this processing, whereby the deblocking filter unit 17 processes the macroblock B101 currently being targeted and the peripheral pixels thereof. Succeeding to or in parallel to this processing, the pixel transfer unit 18 for a deblocking filter transfers the pixels of the macroblocks B153 and B154 to the frame memory 19 from the buffer memory 16. Succeedingly, the region of the buffer memory, in which the pixel values of the macroblock B154 have been stored, is replaced by the pixel values of the macroblock on the right side of the macroblock B152. In this case, the pixel transfer unit 18 for a deblocking filter transfers the pixel values of the macroblock on the right side of the macroblock B152 to the buffer memory from the frame memory 19. In this manner, when the pixel values stored in the buffer memory 16 have been replaced, the deblocking filter unit 17 applies the deblocking filter to the pixel values of the macroblock B151.

FIG. 5 is a diagram for explaining the processing of applying the deblocking filter to the pixel values of the color difference component Cb. In the case of applying the deblocking filter to the color difference component Cb of the macroblock B201, the pixel values of the region shown in FIG. 5 are stored in the buffer memory 16. The regions shown by dotted lines are the peripheral pixels of a macroblock to be processed.

The macroblocks B201 to B204 and the macroblocks B251 to B254 respectively correspond to the macroblocks B101 to B104 and the macroblocks B151 to B154 having been explained with reference to FIG. 4.

A region B255 has a rectangular shape with a height of 4 pixels and a width corresponding to the number of the pixels of the decoded image in the horizontal direction. To be concrete, this region has regions B255a and B255b which are located on different lines with respect to the currently targeted macroblock B201 serving as the border. The region B255a has a rectangular shape with a height of 4 pixels adjacent to the top of a macroblock B203 and a width extending from the right end of the macroblock B203 to the left end of the decoded image. The region B255b has a rectangular shape with a height of 4 pixels adjacent to the top of a macroblock B202 adjacent to the top of the macro block B201 and a width extending from the left end of the macroblock B201 to the right end of the decoded image. When either macroblock B255a or B255b is located outside of the decoded image, the contents of the outside region may be arbitrary. The region B255 may or may not be stored in the same buffer memory as for macroblocks B201 to B204 and B251 to B254.

In the case of applying the deblocking filter to the color difference component Cb, the pixel values of the region shown in FIG. 5 are stored in the buffer memory 16. The color difference component Cb of the macroblock B201 is processed by the operation similar to that explained with reference to FIG. 4. As to the other color difference component Cr, the pixel values having the configuration same as FIG. 5 are stored in the buffer memory 16 and the processing equivalent to the color difference component Cb is repeated.

Next, explanation will be made as to the order where the deblocking filter unit 17 applies the deblocking filter, according to the embodiment.

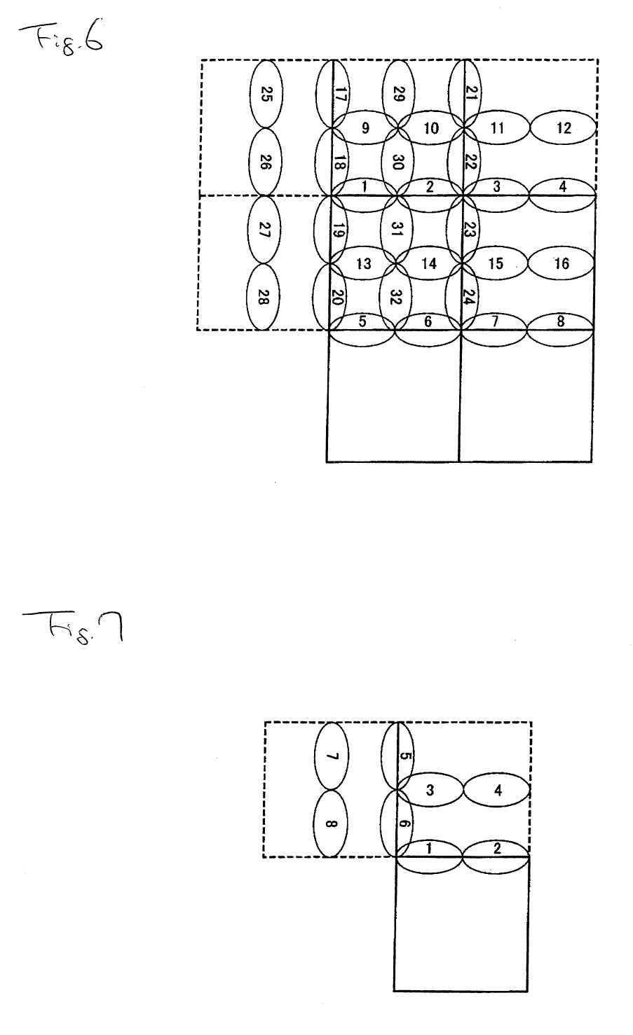

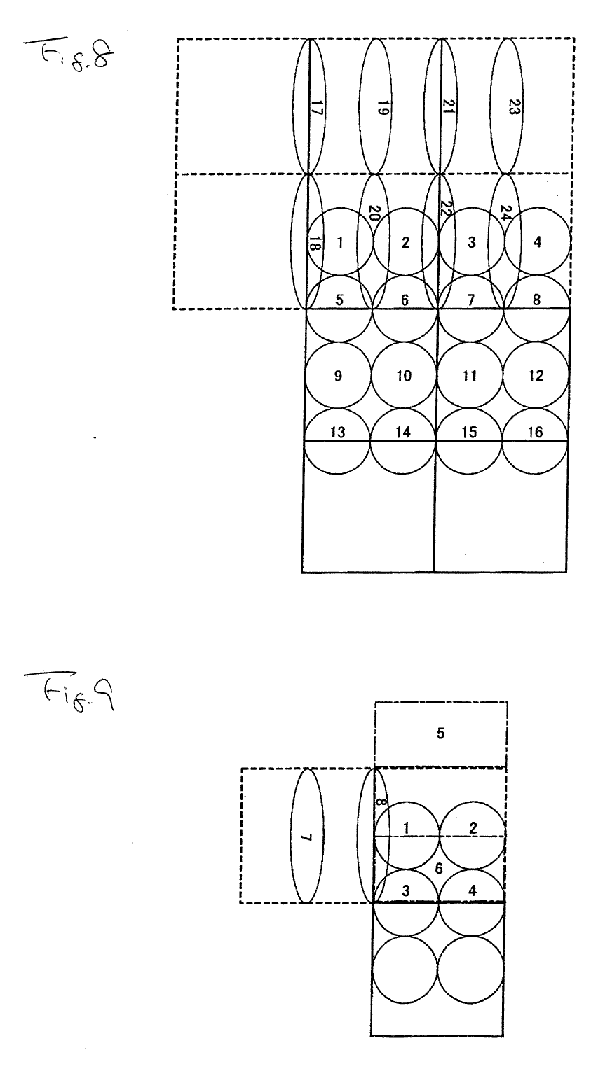

FIGS. 6 and 7 are diagrams for explaining the order where the deblocking filter is applied to a single macroblock of a progressive picture or an interlace field picture. FIGS. 8 and 9 are diagrams for explaining the order where the deblocking filter is applied to a single macroblock of an interlace frame picture.

The explanation will be made with reference to FIG. 6 as to the order where the deblocking filter is applied to the pixel values of the luminance component Y of a single macroblock of a progressive picture or an interlace field picture.

In FIG. 6, a minimum square represents a block of 8 pixels×8 pixels. A square represented by solid lines consisting of four minimum squares corresponds to a macroblock being targeted currently. This macroblock has the size of 16 pixels×16 pixels. Dotted portions represent peripheral macroblocks. Each ellipse collectively represents four block boundaries each formed by two pixels. The deblocking filter is applied to pixel values corresponding to the ellipse portion. Since the deblocking filter has an input of 8 taps, the deblocking filter unit 17 receives not only the pixel values corresponding to the two pixels at the boundary shown by the ellipse but also the pixel values corresponding to 6 pixels in total, that is, 3 pixels on each of the both sides off the boundary. The deblocking filter is applied to each of the ellipses (1) to (32) in the order of the reference numerals sequentially, and the results of the application are written into the buffer memory 16. Whether or not to apply the deblocking filter may be set as to each of the ellipses (1) to (32) as the need arises.

The explanation will be made with reference to FIG. 7 as to the order where the deblocking filter is applied to the pixel values of the color difference component Cb of a single macroblock of a progressive picture or an interlace field picture. The representing method of FIG. 7 is same as FIG. 6. The deblocking filter is applied to each of ellipses (1) to (8) in the order of the reference numerals sequentially, and the results of the application are written into the buffer memory 16. Whether or not to apply the deblocking filter may be set as to each of the ellipses (1) to (8) as the need arises.

The pixel values of the color difference component Cr are also processed in the similar manner as the pixel values of the color difference component Cb.

The explanation will be made with reference to FIG. 8 as to the order where the deblocking filter is applied to the pixel values of the luminance component Y of a single macroblock of an interlace frame picture.

In FIG. 8, each of circles attached with reference numerals 1 to 16 collectively represents 8 boundaries in total, that is, 4 block boundaries each having 2 pixels in the horizontal direction for a top field and another 4 boundaries for a bottom field. Since the deblocking filter has an input of 8 taps, the deblocking filter unit 17 receives not only the pixel values corresponding to the four pixels in total, that is, two pixels at the boundary of each of the top field and the bottom field shown by the circle but also the pixel values corresponding to 8 pixels in total on the both sides, that is, 3 pixels on each of the both sides off the circle. Each of ellipses attached with reference numerals 17 to 24 collectively represents 8 boundaries in total, that is, 4 block boundaries each having 2 pixels in the vertical direction for a top field and another 4 boundaries for a bottom field. This figure is same as FIG. 6 except for these configurations. The deblocking filter is applied to the circles and ellipses (1) to (24) in the order of the reference numerals sequentially, and the results of the application are written into the buffer memory 16. Whether or not to apply the deblocking filter may be set as to each of the circles and ellipses (1) to (24) as the need arises.

Now, explanation will be made with reference to FIG. 9 as to the order where the deblocking filter is applied to the pixel values of the color difference component Cb of a single macroblock of an interlace frame picture. The representing method of FIG. 9 is same as FIG. 8. Each of alternate long and short dash line portions (5) and (6) represents a region of 4 pixels in the vertical direction and 8 pixels in the horizontal direction.

In this case, the deblocking filter is applied to the circles or ellipses (1) to (4) in the order of the reference numerals sequentially, and the results of the application are written into the buffer memory 16. Next, the area of the buffer memory storing the alternate long and short dash line portion (5) is replaced by the content of the buffer memory storing the alternate long and short dash line portion (6). At the last, the deblocking filter is applied to the ellipses (7) and (8) in the order of the reference numerals sequentially, and the results of the application are written into the buffer memory 16. Whether or not to apply the deblocking filter may be set as to each of the circles (1) to (4) and the ellipses (7) and (8) as the need arises. These operations are also repeated for the other color difference component Cr.

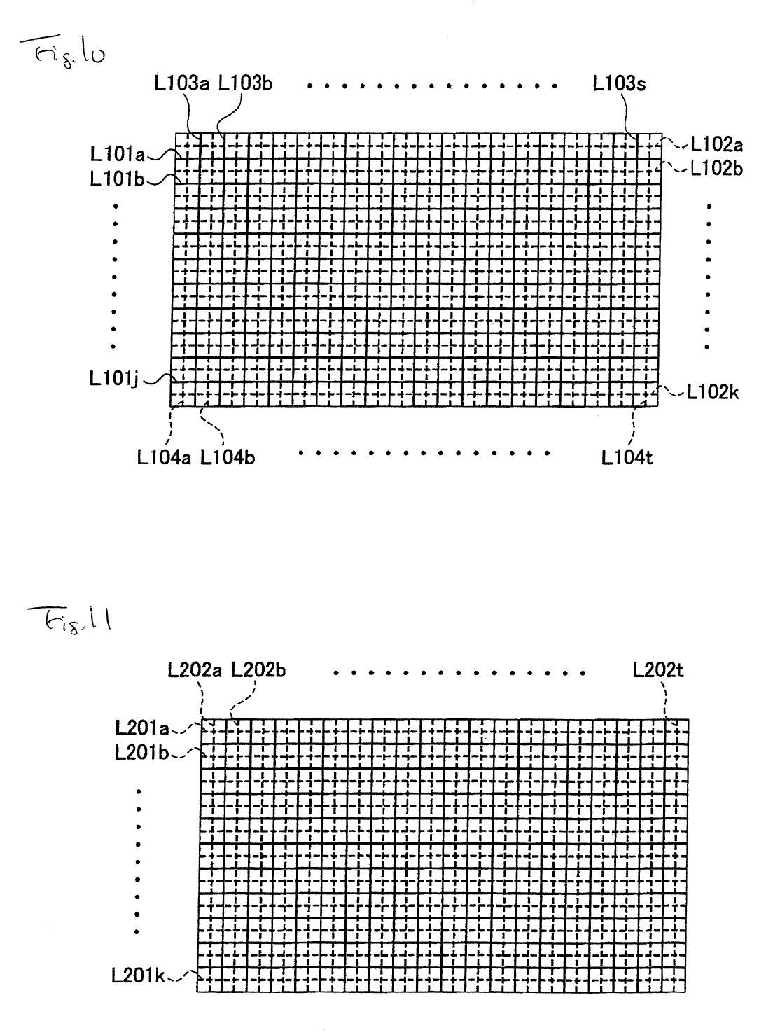

Now, explanation will be made with reference to FIGS. 10 and 11 as to the application order of the deblocking filter in the related art.

FIG. 10 is a diagram for explaining the application order to a progressive picture or an interlace field picture. FIG. 10 shows a sheet of image to which the deblocking filter is not applied yet. In this case, the following procedure is required:

(1) The deblocking filter processing is conducted on boundaries L101a, L101b, . . . , L101j each extending in the horizontal direction and being disposed between adjacent blocks each having 8 pixels×8 pixels, over the entirety of the sheet of image;

(2) The deblocking filter processing is conducted on boundaries L102a, L102b, . . . , L102k each extending in the horizontal direction and being disposed between adjacent subblocks each having 4 pixels×4 pixels, over the entirety of the sheet of image;

(3) The deblocking filter processing is conducted on boundaries L103a, L103b, . . . , L103s each extending in the vertical direction and being disposed between adjacent blocks each having 8 pixels×8 pixels, over the entirety of the sheet of image; and

(4) The deblocking filter processing is conducted on boundaries L104a, L104b, . . . , L104t each extending in the vertical direction and being disposed between adjacent subblocks each having 4 pixels×4 pixels, over the entirety of the sheet of image.

In the image shown in FIG. 10, the luminance component is processed based on the macroblock of 16 pixels×16 pixels, whilst the one color difference component is processed based on the macroblock of 8 pixels×8 pixels. The pixel values are read from and written into the buffer memory 16 in the following manners concerning the aforesaid procedures respectively as to a sheet of image having a width of “w” macro-blocks and a height of “h” macro-blocks:

(1) (w×h×384−w×192) pixels for reading, and (w×h×384/4−w×64) pixels for writing;

(2) (w×h×384) pixels for reading, and (w×h×384/4) pixels for writing;

(3) (w×h×384−h×192) pixels for reading, and (w×h 384−h×64) pixels for writing; and

(4) (w×h×384) pixels for reading, and (w×h×384/4) pixels for writing.

When these pixels are summed up, it will be understood that (w×h×384×5−(w+h)×256) pixels are accessed to the buffer memory 16.

FIG. 11 is a diagram for explaining the application order to an interlace frame picture. FIG. 11 shows a sheet of image to which the deblocking filter is not applied yet. In this case, the following procedure is required:

(1) The deblocking filter processing is conducted on boundaries L201a, L201b, . . . , L201k each extending in the horizontal direction and being disposed between adjacent blocks each having 8 pixels×8 pixels and between adjacent subblocks each having 4 pixels×4 pixels, as to a top field and a bottom field independently from the upper direction toward the lower direction, over the entirety of the sheet of image; and

(2) The deblocking filter processing is conducted on boundaries L202a, L202b, . . . , L202t each extending in the vertical direction and being disposed between adjacent blocks each having 8 pixels×8 pixels and between adjacent subblocks each having 4 pixels×4 pixels, as to a top field and a bottom field independently from the left side to the right side, over the entirety of the sheet of image.

In the image shown in FIG. 11, the luminance component is processed based on the macroblock of 16 pixels×16 pixels, whilst the one color difference component is processed based on the macroblock of 8 pixels×8 pixels. The pixel values are read from and written into the buffer memory 16 in the following manners as to a sheet of image having a width of “w” macro-blocks and a height of “h” macro-blocks:

(1) (w×h×192) pixels for reading of one field, and (w×h×192−w×192) pixels for writing of one field; and

(2) (w×h×192) pixels for reading of one field, and (w×h×192/2−w×32) pixels for writing of one field.

Since this processing is requited for two fields of the top field and the bottom field, it will be understood that (w×h×384×3.5−w×384−h×64) pixels in total are accessed to the buffer memory 16.

In contrast to the above described related-art method, explanation will be made as to the image processing apparatus 1 according to the embodiment of the invention. In the processing of a single macroblock, an amount of data transferred from the buffer memory 16 to the frame memory 19 will be 768 pixels, or two macroblocks, of the macro blocks B153 and B154 as to the luminance component Y and the macro blocks B253 and B254 as to the color difference components Cb and Cr corresponding thereto, respectively. In contrast, an amount of data transferred from the frame memory 19 to the buffer memory 16 will be 384 pixels of the macroblock B152 as to the luminance component Y and the macroblock B252 as to the color difference components Cb and Cr corresponding thereto, respectively. Thus, in the case of an image of a single screen with w macroblocks×h macroblocks, (w×h×384×3) pixels in total are transferred. This means that an amount of pixels being transferred can be reduced as compared with the aforesaid method of the related art as to each of the progressive picture, interlace field picture and interlace frame picture.

In this manner, the image processing apparatus 1 according to the embodiment can reduce an amount of pixels being transferred as to the deblocking filtering processing.

Further, in the image processing apparatus 1 according to the embodiment, the deblocking filter can be applied on a macroblock unit basis. Thus, when the decoding process just before the deblocking filtering of a predetermined macroblock terminates, the deblocking filter can be applied to the predetermined macroblock. Accordingly, as compared with the method of the related art in which the deblocking filter is applied after the decoding processing terminates as to the entirety of an image, the image processing apparatus 1 according to the embodiment of the invention can reduce a time period required for the decoding process.

In this manner, according to the image processing apparatus 1 according to the embodiment, it is possible to output a decoded image to which the deblocking filter is applied efficiently.

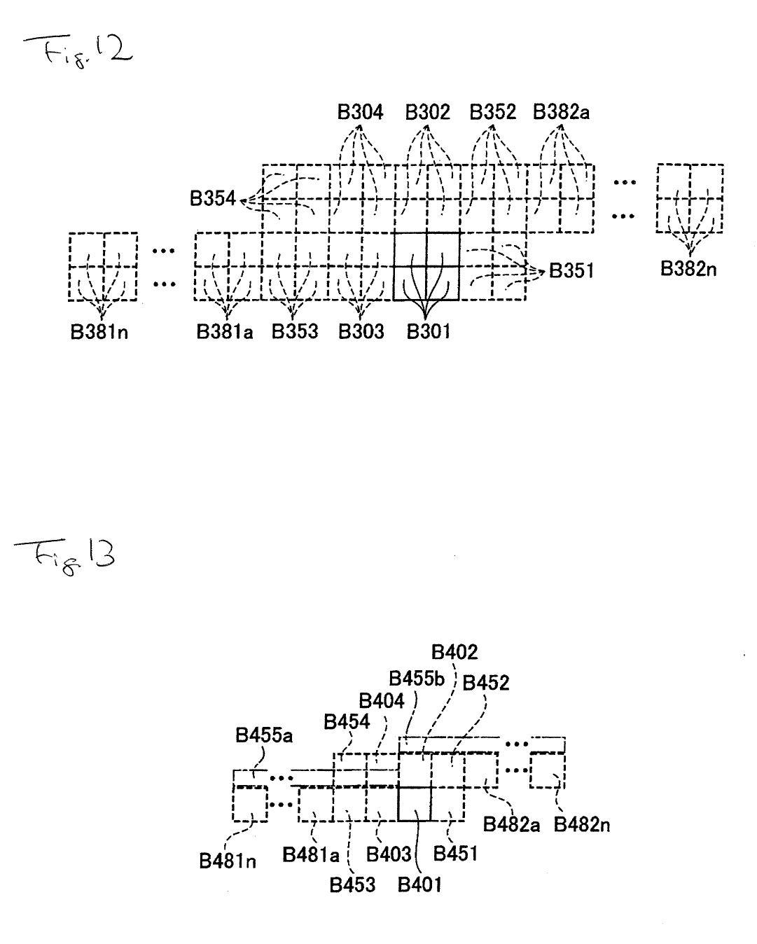

Next, explanation will be made with reference to FIGS. 12 and 13 as to a method of applying the deblocking filter in the image processing apparatus according to a modified example of the embodiment of the invention. In the modified example of the embodiment, since a capacity of the buffer memory 16 is set larger as compared with the embodiment of the invention, an amount of data transferred between the buffer memory 16 and the frame memory is reduced.

The explanation will be made with reference to FIG. 12 as to pixel values stored in the buffer memory 16 in the case of applying the deblocking filter to the pixel values of a luminance component. A region shown in FIG. 12 differs from FIG. 4 referred in the embodiment of the invention in a point that this region further includes macroblocks B381a to B381n and macroblocks B382a to B382n. Macroblocks B301 to B304 and macroblocks B351 to B354 shown in FIG. 12 correspond to the macroblocks B101 to B104 and the macroblocks B151 to B154 shown in FIG. 4, respectively. The macroblocks B381a to B381n are a group of macroblocks expanding toward the left end of an image from the left of the currently targeted macroblock B301 except for a macroblock B303 processed before the currently targeted macroblock B301 and a macroblock B353 processed before the macroblock B303. Similarly, the macroblocks B382a to B382n are a group of macroblocks expanding toward the right end of the image from the right of a macroblock B302 on top of the currently targeted macroblock B301 except for the macroblock B302 on the currently targeted macroblock B301 and a macro clock B352 to be processed next to the macroblock B302. The buffer memory 16 has a capacity capable of storing simultaneously the pixel values of the region shown in FIG. 12.

Next, the operation will be explained. First, the inter-frame prediction application unit 15 writes the pixel values of the macroblock B351. Then, the deblocking filter unit 17 operates to process the pixel values of the currently targeted macroblock B301 and the macroblocks B302 to B304 at the periphery thereof. Succeeding to or in parallel to this processing, the pixel transfer unit 18 for a deblocking filter transfers the pixel values of the macroblock B354 to the frame memory 19 from the buffer memory 16. When the macroblocks B351, B354 and the macroblocks B301 to B304 are stored in different buffer memories, respectively, these memories may be operated in parallel thereby to operate the processing at a higher speed. In this manner, a series of the deblocking filter process as to the macroblock B301 terminate and so the macroblock to be targeted next is the macroblock B351.

The explanation will be made with reference to FIG. 13 as to pixel values stored in the buffer memory 16 in the case of applying the deblocking filter to the pixel values of a color difference component. A region shown in FIG. 13 differs from FIG. 5 referred in the embodiment of the invention in a point that this region further includes macroblocks B481a to B481n and macroblocks B482a to B482n. Macroblocks B401 to B404 and macroblocks B451 to B455 shown in FIG. 13 correspond to the macroblocks B201 to B204 and the macroblocks B251 to B255 shown in FIG. 5, respectively. The macroblocks B481a to B481n are a group of macroblocks expanding toward the left end of an image from the left side of the currently targeted macroblock B401 except for a macroblock B403 processed before the currently targeted macroblock B401 and a macroblock B453 processed before the macroblock B403. Similarly, the macroblocks B382a to B382n are a group of macroblocks expanding toward the right end of the image from the right side of a macroblock B302 on top of the currently targeted macroblock B301 except for the macroblock B302 on the currently targeted macroblock B301 and a macroblock B352 to be processed next to the macroblock B302. The buffer memory 16 has a capacity capable of storing simultaneously the pixel values of the region shown in FIG. 12.

Next, the operation will be explained. First, the inter-frame prediction application unit 15 writes the pixel values of the macroblock B451. Succeeding to or in parallel to this writing processing, the deblocking filter unit 17 operates to process the pixel values of the currently targeted macroblock B401 and the macroblocks B402 to B404 at the periphery thereof. Succeeding to or in parallel to this processing, the pixel transfer unit 18 for a deblocking filter transfers the pixel values of the macroblock B454 to the frame memory 19 from the buffer memory 16. When the macroblocks B451, B454 and the macroblocks B401 to B404 are stored in different buffer memories, respectively, these memories may be operated in parallel thereby to operate the processing at a higher speed. In this manner, a series of the deblocking filtering process as to the macroblock B401 terminate and so a macroblock to be targeted next is the macroblock B451.

According to the modified example of the embodiment, only 384 pixels of the macroblocks B354 and B454 is transferred from the buffer memory 16 to the frame memory 19 for each processing of a single macroblock. Thus, when a screen is formed by an image of w macroblocks×h macroblocks, (w×h×384) pixels in total are transferred. Thus, as compared with the method of the related art, an amount of data transfer can be reduced as to each of a progressive picture, interlace field picture and interlace frame picture.

Further, according to the modified example of the embodiment, when the capacity of the buffer memory 16 is increased, an amount of data transfer between the buffer memory 16 and the frame memory 19 can be reduced as compared with the embodiment that is previously described.

In this manner, according to the image processing apparatus 1 according to the modified example of the embodiment, a decoded image to which the deblocking filter is efficiently applied can be output.

As described with reference to the embodiment and the modified example thereof, there is provided an image processing apparatus and an image processing method each of which outputs coded images to which a deblocking filter is applied efficiently.

What is claimed is:

1. An image processing apparatus that applies a deblocking filter to an image, the apparatus comprising:
a frame memory;
a buffer memory that stores pixel values of macroblocks of a first region including a first macroblock;
a deblocking filter unit that is operable to:
(1) read out the pixel values of the first region from the buffer memory;
(2) apply the deblocking filter to the first macroblock; and
(3) store the pixel values being applied with the deblocking filter back into the buffer memory; and
a pixel transfer unit that is operable-to:
(4) transfer pixel values of a macroblock not included in a second region that includes a second macroblock to be processed next to the first macroblock, from the buffer memory to the frame memory; and
(5) transfer pixel values of a macroblock included in the second region but not included in the first region, from the frame memory to the buffer memory.

2. The apparatus according to claim 1, wherein the deblocking filter unit applies the deblocking filter to a luminance component of the pixel values included in the first macroblock having a size of 16×16 pixels.

3. The apparatus according to claim 2, wherein the deblocking filter unit applies the deblocking filter to the luminance component of the pixel values of the image of an interlace field picture.

4. The apparatus according to claim 1, wherein the deblocking filter unit applies the deblocking filter to a color difference component of the pixel values included in the first macroblock having a size of 8×8 pixels.

5. The apparatus according to claim 4, wherein the deblocking filter unit applies the deblocking filter to the color difference component of the pixel values of the image of a progressive picture or an interlace field picture.

6. The apparatus according to claim 4, wherein the deblocking filter unit applies the deblocking filter to a color difference component of the pixel values included in the first macroblock having a size of 8×8 pixels.

7. An image processing apparatus that applies a deblocking filter to an image, the apparatus comprising:
a frame memory;
an inter-frame prediction application unit that calculates pixel values of a macroblock;
a buffer memory that stores the pixel values of the macroblock output from the inter-frame prediction application unit;
a deblocking filter unit that is operable to:
(1) read out the pixel values of the macroblock from the buffer memory;
(2) apply the deblocking filter to the macroblock; and
(3) store the pixel values being applied with the deblocking filter back into the buffer memory; and
a pixel transfer unit that transfers the pixel values stored in the buffer memory to the frame memory.

8. The apparatus according to claim 7, wherein the deblocking filter unit applies the deblocking filter to a luminance component of the pixel values included in the first macroblock having a size of 16×16 pixels.

9. The apparatus according to claim 8, wherein the deblocking filter unit applies the deblocking filter to the luminance component of the pixel values of the image of an interlace field picture.

10. The apparatus according to claim 7, wherein the deblocking filter unit applies the deblocking filter to a color difference component of the pixel values included in the first macroblock having a size of 8×8 pixels.

11. The apparatus according to claim 10, wherein the deblocking filter unit applies the deblocking filter to the color difference component of the pixel values of the image of a progressive picture or an interlace field picture.

12. The apparatus according to claim 10, wherein the deblocking filter unit applies the deblocking filter to a color difference component of the pixel values included in the first macroblock having a size of 8×8 pixels.

13. An image processing method for applying a deblocking filter to an image, the method comprising:
calculating pixel values of a first macroblock;
storing the pixel values into a buffer memory;
reading out pixel values of a first region including a first macroblock from the buffer memory;
applying the deblocking filter to the first macroblock;
storing the pixel values being applied with the deblocking filter back into the buffer memory;
transferring pixel values of a macroblock not included in a second region that includes a second macroblock to be processed next to the first macroblock, from the buffer memory to the frame memory; and
transferring pixel values of a macroblock included in the second region but not included in the first region, from the frame memory to the buffer memory.

14. The method according to claim 13, wherein the deblocking filter is applied to a luminance component of the pixel values included in the first macroblock having a size of 16×16 pixels.

15. The method according to claim 14, wherein the deblocking filter is applied to the luminance component of the pixel values of the image of an interlace field picture.

16. The method according to claim 13, wherein the deblocking filter is applied to a color difference component of the pixel values included in the first macroblock having a size of 8×8 pixels.

17. The method according to claim 16, wherein the deblocking filter is applied to the color difference component of the pixel values of the image of a progressive picture or an interlace field picture.

18. The method according to claim 16, wherein the deblocking filter is applied to a color difference component of the pixel values included in the first macroblock having a size of 8×8 pixels.
